(19) United States
(12) Patent Application Publication
(10) Pub. No.: US 2025/0136004 A1
(43) Pub. Date: May 1, 2025

(54) SLIDE TRANSFER DEVICE FOR VEHICLE

(71) Applicants: Hyundai Motor Company, Seoul (KR); Kia Corporation, Seoul (KR); KBI Dongkook Ind. Co., Ltd., Seoul (KR)

(72) Inventors: Jung Hoon Woo, Suwon-si (KR); Dae Hee Lee, Incheon (KR); Hong Sik Chang, Hwaseong-si (KR); Jin Suk Seo, Seoul (KR); Hye Kyung Kim, Suwon-si (KR); Kwan Woo Lee, Suwon-si (KR); Dong il Son, Ulsan (KR); Dong Hyuk Choi, Ulsan (KR); Chang Bok Park, Hwaseong-si (KR); Dong Yong Choi, Suwon-si (KR); O Sim Kwon, Ulsan (KR); Sun Kyung Kim, Ulsan (KR)

(21) Appl. No.: 18/582,952

(22) Filed: Feb. 21, 2024

(30) Foreign Application Priority Data
Oct. 31, 2023 (KR) 10-2023-0147801

(51) Int. Cl. B60R 7/04

(52) U.S. Cl. CPC B60R 7/04

(57) ABSTRACT

An embodiment sliding transfer device for a vehicle includes a first rail part fixable to a vehicle body, a second rail part coupled to the first rail part and slidably movable in a forward-and-rearward direction of the first rail part, a plurality of sensors comprising a first sensor mounted at a front side of the first rail part and a second sensor mounted at a rear side of the first rail part, wherein each of the sensors is configured to generate a sensing signal in a case in which the second rail part reaches a set limit position thereof, and a controller configured to selectively control, based on the sensing signal, an operation of a drive motor for sliding movement of the second rail part.

### CROSS-REFERENCE TO RELATED APPLICATIONS

This application claims the benefit of Korean Patent Application No. 10-2023-0147801, filed on Oct. 31, 2023, which application is hereby incorporated herein by reference.

### TECHNICAL FIELD

The present disclosure relates to a sliding transfer device for a vehicle.

### BACKGROUND

Generally, examples of a storage space formed in a vehicle include a console box, a glove box, and an overhead box. These storage spaces are formed at different locations in the vehicle and are provided to store various items used in the vehicle. Further, these storage spaces are installed to be openable and closable by a user.

Among these storage spaces, the box-shaped console box is a storage compartment between the driver's seat and the front passenger seat and is located near a gear shift lever. This console box is also commonly referred to as a center console.

Here, since the console box is provided between the driver's seat and the front passenger seat, a user may easily use items stored therein. Accordingly, a user may conveniently store frequently used items in the console box. Since an upper portion of the console box is generally made of a soft material, the upper portion may be used as an armrest for a driver or a passenger.

Meanwhile, an autonomous driving system is mounted in a recently manufactured vehicle, and the autonomous driving system provides a function of controlling a vehicle to automatically drive the vehicle without driver involvement.

That is, an autonomous driving function currently installed in the vehicle may partially support autonomous driving. For example, the autonomous driving function is capable of controlling the vehicle's speed and steering wheel angle, parking assistance, obstacle avoidance, and the like. With increasing interest in the autonomous driving function, research and development has been actively conducted on an autonomous driving technique.

Therefore, when the technical limitations of the autonomous driving function are solved, there is a high possibility of achieving a fully autonomous driving function. Accordingly, the autonomous driving function enables a user to perform various activities during driving of the vehicle by utilizing a space in the vehicle.

Generally, a conventional console box provided in a vehicle is fixedly mounted on the vehicle body and is disposed between the driver's seat and the front passenger seat. Further, the console box plays an important role in forming a space on the front seat side. Accordingly, as described above, as the scope of the autonomous driving function expands, it is required to efficiently utilize a space in a vehicle by providing a movable console box.

Particularly, there is demand for research and development on an operation mechanism configured to allow a user to easily and quickly move the console box in the vehicle space.

The above information disclosed in this background section is only for enhancement of understanding of the background of embodiments of the invention, and therefore it may contain information that does not form the prior art that is already known to a person of ordinary skill in the art.

### SUMMARY

The present disclosure relates to a sliding transfer device for a vehicle. Particular embodiments relate to a sliding transfer device for a vehicle configured to sense, by a limit sensor provided therein, a sliding movement position of an upper rail when the upper rail is slidably moved along a lower rail, thereby preventing overload of a motor due to sliding movement of the upper rail.

Embodiments of the present disclosure can solve problems associated with the prior art, and an embodiment of the present disclosure provides a sliding transfer device for a vehicle, the sliding transfer device including a movement guide, formed to protrude from a lower rail and configured to allow an upper rail to be slidably moved in the longitudinal direction of the movement guide when the upper rail slides along the lower rail, and a contactless limit sensor provided to sense the sliding movement position of the upper rail and configured to change the direction of the upper rail or stop the movement thereof at a limit position of the front of the upper rail and a limit position of the rear thereof, thereby preventing overload of a drive motor due to sliding movement of the upper rail.

One embodiment of the present disclosure provides a sliding transfer device for a vehicle, the sliding transfer device including a first rail part fixed to a vehicle body, a second rail part coupled to the first rail part and formed to be slidably moved in a forward-and-rearward direction of the first rail part, sensors respectively mounted at a front side of the first rail part and a rear side thereof, wherein each of the sensors is configured to generate a sensing signal when the second rail part reaches a set limit position thereof, and a controller configured to selectively control, based on the sensing signal, an operation of a drive motor for sliding movement of the second rail part.

In a preferred embodiment, each of the stoppers may be made of an elastic material and may be formed to stand upright from a corresponding one of the front side of the first rail part and the rear side thereof.

In another preferred embodiment, the sliding transfer device may further include a guidance rail part formed to shield an upper part of the first rail part, wherein the guidance rail part may include a pair of sliding slots formed to extend in a longitudinal direction and configured to allow the second rail part to be slidably moved along the pair of sliding slots.

In still another preferred embodiment, the first rail part may include shielding members respectively mounted on the front side of the first rail part and the rear side thereof and configured to shield the pair of sliding slots selectively withdrawn and opened by the slidably movable second rail part.

In yet another preferred embodiment, the second rail part may be slidably moved in a state of being coupled to a movement guide formed to protrude from the first rail part.

In still yet another preferred embodiment, the movement guide may be formed to extend upwards with an inclination on an upper surface of the first rail part and may be inserted into a mounting hole of the second rail part.

In a further preferred embodiment, the controller may be configured to perform, upon receiving the sensing signal indicating that the second rail part slides and reaches the limit position, a control operation of changing a rotation direction of the drive motor.

In another further preferred embodiment, the controller may be configured to perform, upon receiving the sensing signal indicating that the second rail part slides and reaches the limit position, a control operation of releasing the operation of the drive motor.

In still another further preferred embodiment, the sensor may be an electronic contactless sensor.

In yet another further preferred embodiment, the sliding transfer device may further include a cable part connected to a main wiring slidably moved with the second rail part, the cable part being electrically connected to the main wiring, and a cable body part formed to allow, when the second rail part is slidably moved in the forward-and-rearward direction of the first rail part, the cable part to be selectively withdrawn therefrom or stored therein.

In still yet another further preferred embodiment, the cable part may include a connector member electrically connected to the main wiring and a withdrawal member connected to the connector member and formed to extend in a left-and-right direction of the second rail part, wherein the withdrawal member may be wound in the cable body part fixedly mounted on the first rail part.

In a still further preferred embodiment, the withdrawal member may be a flexible flat cable (FFC).

Other aspects and preferred embodiments of the disclosure are discussed infra.

It is understood that the terms “vehicle”, “vehicular”, and other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

The above and other features of embodiments of the disclosure are discussed infra.

### BRIEF DESCRIPTION OF THE DRAWINGS

The above and other features of embodiments of the present disclosure will now be described in detail with reference to certain exemplary embodiments thereof illustrated in the accompanying drawings which are given hereinbelow by way of illustration only, and thus are not limitative of the embodiments of the present disclosure, and wherein:

FIG. 1 is a diagram schematically showing a sliding transfer device for a vehicle according to an embodiment of the present disclosure;

FIG. 2 is a diagram showing a configuration of the sliding transfer device for the vehicle according to an embodiment of the present disclosure;

FIG. 3 is a cross-sectional view taken along line A-A in FIG. 1 and shows a coupling structure between a first rail part and a second rail part of the sliding transfer device for the vehicle according to an embodiment of the present disclosure;

FIG. 4 is a diagram showing a shielding member provided in the sliding transfer device for the vehicle according to an embodiment of the present disclosure;

FIG. 5 is a cross-sectional view taken along line B-B in FIG. 1 and shows a shielding structure of a sliding slot provided in the sliding transfer device for the vehicle according to an embodiment of the present disclosure;

FIG. 6 is a diagram showing a mounting position of a stopper provided in the sliding transfer device for the vehicle according to the embodiment of the present disclosure;

FIGS. 7 and 8 are diagrams showing an operation state of the stopper provided in the sliding transfer device for the vehicle according to an embodiment of the present disclosure; and

FIG. 9 is a diagram showing an operation state of a sensor provided in the sliding transfer device for the vehicle according to an embodiment of the present disclosure.

It should be understood that the appended drawings are not necessarily to scale, presenting a somewhat simplified representation of various preferred features illustrative of the basic principles of embodiments of the disclosure. The specific design features of embodiments of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawings.

### DETAILED DESCRIPTION OF ILLUSTRATIVE EMBODIMENTS

Hereinafter, reference will be made in detail to various embodiments of the present disclosure, examples of which are illustrated in the accompanying drawings and described below.

Advantages and features of embodiments of the present disclosure and a method of achieving the same will become apparent with reference to the embodiments described below in detail in conjunction with the accompanying drawings.

However, the embodiments of the present disclosure re not limited by the embodiments disclosed below and may be implemented in various forms. The embodiments are provided to ensure that the disclosure of the present disclosure is complete and to fully inform the scope of the disclosure to those skilled in the art to which the present disclosure pertains, and the embodiments of the present disclosure are only defined by the scope of the claims.

Furthermore, in the description of embodiments of the present disclosure, if it is determined that related known technologies may obscure the gist of the embodiments of the present disclosure, a detailed description thereof will be omitted.

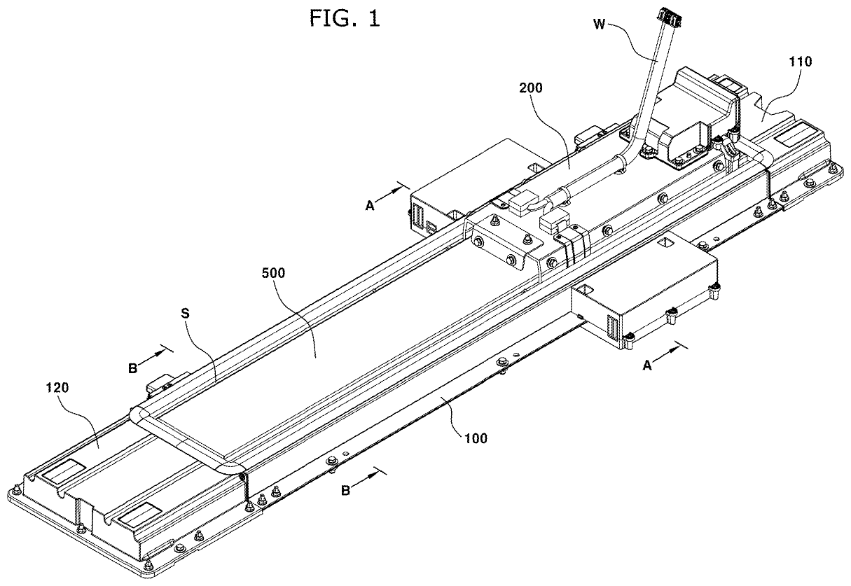

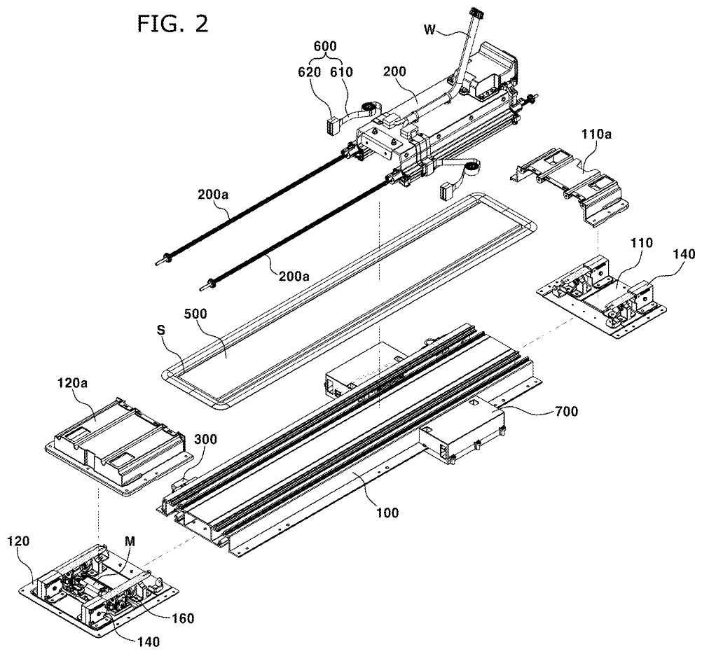

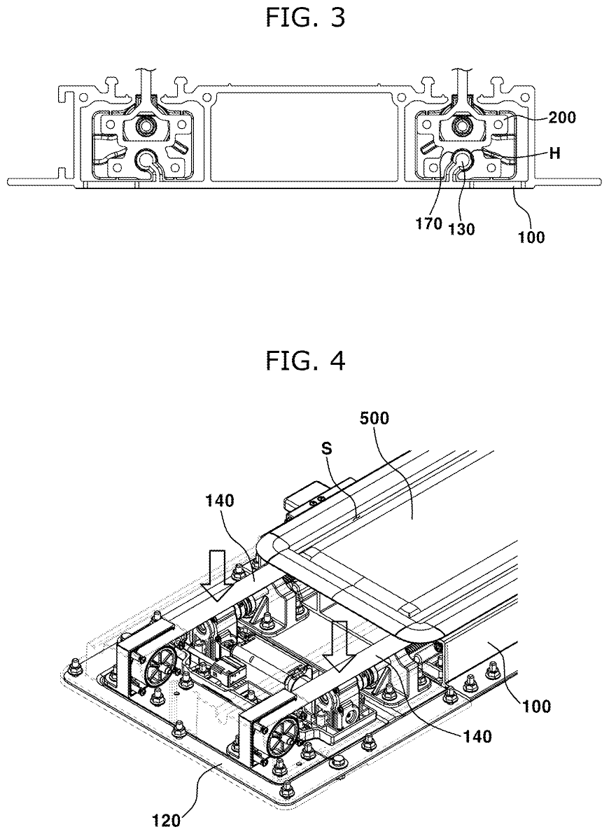

FIG. 1 is a diagram schematically showing a sliding transfer device for a vehicle according to an embodiment of the present disclosure, FIG. 2 is a diagram showing a configuration of the sliding transfer device for the vehicle according to an embodiment of the present disclosure, and FIG. 3 is a cross-sectional view taken along line A-A in FIG. 1 and shows a coupling structure between a first rail part and a second rail part of the sliding transfer device for the vehicle according to an embodiment of the present disclosure.

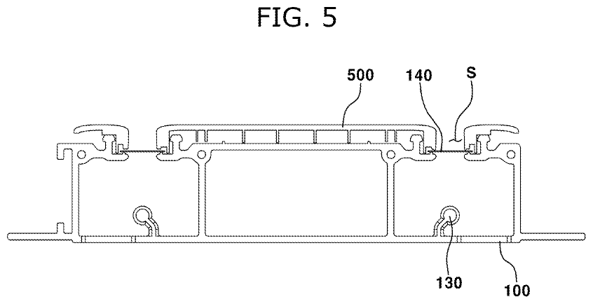

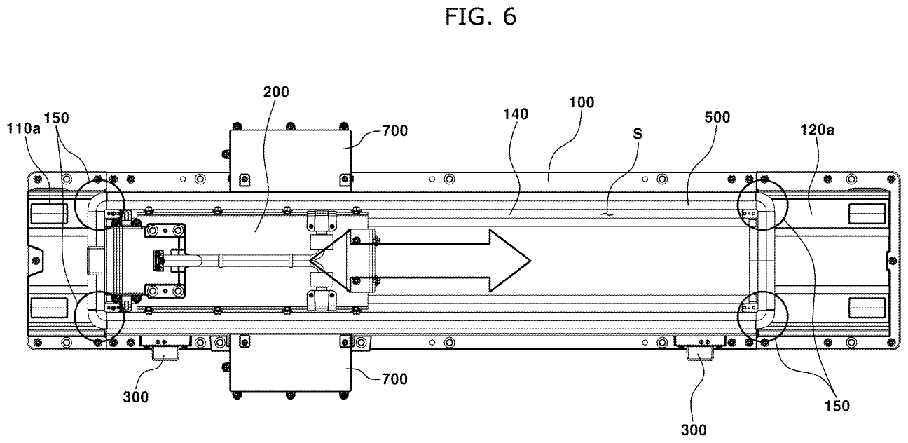

FIG. 4 is a diagram showing a shielding member provided in the sliding transfer device for the vehicle according to an embodiment of the present disclosure, FIG. 5 is a cross-sectional view taken along line B-B in FIG. 1 and shows a shielding structure of a sliding slot provided in the sliding transfer device for the vehicle according to an embodiment of the present disclosure, and FIG. 6 is a diagram showing a mounting position of a stopper provided in the sliding transfer device for the vehicle according to an embodiment of the present disclosure.

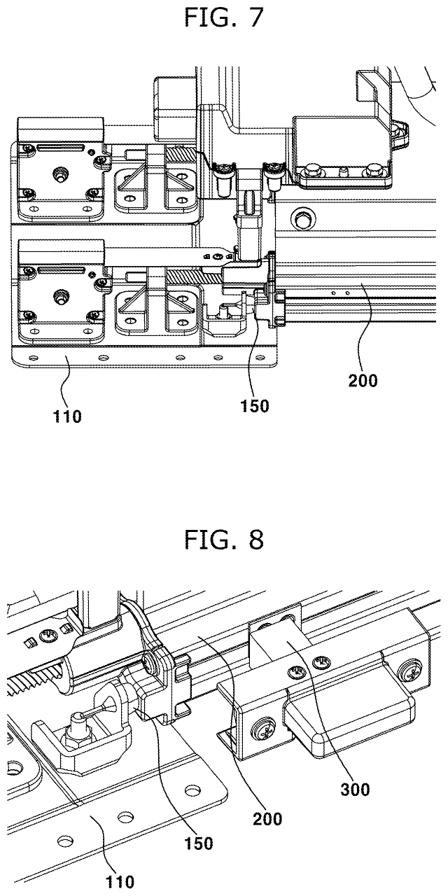

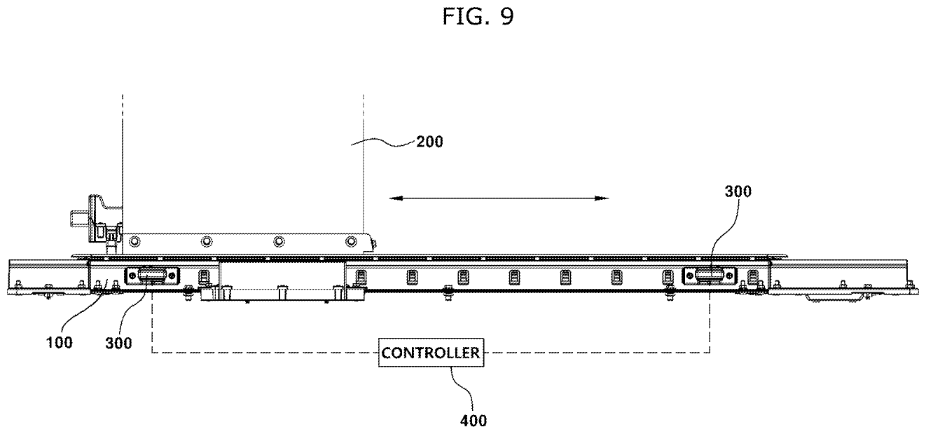

FIGS. 7 and 8 are diagrams showing an operation state of the stopper provided in the sliding transfer device for the vehicle according to an embodiment of the present disclosure, and FIG. 9 is a diagram showing an operation state of a sensor provided in the sliding transfer device for the vehicle according to an embodiment of the present disclosure.

Generally, as a structure capable of being slidably transferred, for example, a structure such as a vehicle center console is a structure installed in the space defined between the driver's seat and the front passenger seat in a vehicle. This vehicle center console is equipped with various types of electrical components such as a universal serial bus (USB) and a shift-by-wire (SBW) system and is also used as a storage place to store items used by a driver and a passenger during driving of the vehicle.

The vehicle center console is generally provided in a vehicle including two or more rows of seats. Here, the vehicle center console is mounted in the vehicle and is slidably moved between the driver's seat and the front passenger seat to maximally provide convenience to a passenger seated on the rear seat.

To this end, the sliding transfer device for the vehicle according to an embodiment includes a first rail part 100 and a second rail part 200, as shown in FIGS. 1 and 2.

The first rail part 100 and the second rail part 200 are provided in a state of being coupled to each other. More specifically, the second rail part 200 is coupled to the first rail part 100 to be slidably moved in the forward-and-rearward direction of the first rail part 100. Here, the first rail part 100 has a longer length than that of the second rail part 200 and is fixedly coupled to a vehicle body.

Preferably, the first rail part 100 and the second rail part 200 may be referred to as a lower rail and an upper rail, respectively.

Accordingly, in a state in which the second rail part 200 corresponding to the upper rail is slidably mounted on the first rail part 100 corresponding to the lower rail, when a structure such as a center console is moved between the first row seat and the second row seat, the second rail part 200 having the structure coupled thereto is slidably moved in the forward-and-rearward direction of the first rail part 100.

Here, as shown in FIG. 3, the first rail part 100 may be provided with a movement guide 130 formed to protrude toward the second rail part 200 coupled to the first rail part 100. The movement guide 130 is bent at a predetermined inclination on the upper surface of the first rail part 100 and is inserted into a mounting hole H of the second rail part 200. Accordingly, when the second rail part 200 is slidably moved, the movement guide 130 prevents the second rail part 200 from being separated from the first rail part 100, thereby stably performing sliding movement of the second rail part 200.

More preferably, a bearing 170 may be installed in the mounting hole H to support a head portion of the movement guide 130, and the second rail part 200 slides along the first rail part 100 through this bearing 170. At this time, the bearing 170 may absorb shock in the left-and-right direction and the upward-and-downward direction, thereby making it possible to solve problems related to noise and vibration that may be generated when the second rail part 200 is slidably moved along the first rail part 100.

Meanwhile, the first rail part 100 has a front panel assembly 110 and a rear panel assembly 120 respectively coupled to the front of the first rail part 100 and the rear thereof, in which the front panel assembly 110 and the rear panel assembly 120 are provided in a state of being shielded from the outside by covers 110a and 120a, respectively. The front panel assembly 110 and the rear panel assembly 120 include a plurality of components. Here, since the rear panel assembly 120 fixes and supports lead screws 200a, the second rail part 200 screwed to the lead screws 200a may be slidably moved when the lead screws 200a are rotated by driving of a drive motor M provided in the rear panel assembly 120 (refer to FIG. 2).

However, in the case of a rail combination structure of the first rail part 100 and the second rail part 200, when the second rail part 200 is slidably moved back and forth, the first rail part 100 may be exposed to the outside through a sliding slot S of a guidance rail part 500. In this case, a foreign substance and the like may flow into the first rail part 100 due to exposure of the first rail part 100 to the outside.

Accordingly, the sliding transfer device for the vehicle according to an embodiment may prevent the above-described problems in advance by providing a shielding member 140.

That is, the guidance rail part 500 is formed to shield the upper part of the first rail part 100 and includes a pair of sliding slots S configured to allow the second rail part 200 to be inserted thereinto to be slidably moved along the sliding slots S. As shown in FIG. 4, the first rail part 100 includes a pair of the shielding members 140 configured to shield the selectively opened sliding slots S.

More specifically, the shielding members 140 are mounted at the front of the first rail part 100 and the rear thereof, respectively, and are formed to be withdrawn by the slidably movable second rail part 200. Accordingly, when the second rail part 200 is slidably moved, the shielding members 140 are withdrawn along a sliding movement path of the second rail part 200. In this manner, as shown in FIG. 5, the sliding slots S may be shielded.

Meanwhile, as shown in FIGS. 6 and 7, the first rail part 100 includes stoppers 150. A plurality of the stoppers 150 are mounted spaced apart from sensors 300 at a plurality of positions. More specifically, the stoppers 150 are mounted spaced apart from the rear sides of the sensors 300, and the same are configured to limit the position of the second rail part 200 moving beyond the limit position thereof.

In other words, each of the stoppers 150 is made of an elastic material and is formed to stand upright with a predetermined height from a corresponding one of the front of the first rail part 100 and the rear thereof. Through this structure, it is possible to prevent, in advance, problems related to noise and damage by mitigating shock caused by the second rail part 200 that is further moved or is forcibly moved.

For example, when a problem related to an operation error occurs in the sensor 300 to be described later, the sensor may not generate a sensing signal. In this case, even if the second rail part 200 configured to be slidably moved by the drive motor M reaches a limit position thereof previously set at the front of the second rail part 200 and the rear thereof, the second rail part 200 may be further moved to a position beyond the limit position.

In this case, as shown in FIG. 8, each of the stoppers 150 blocks further sliding movement of the second rail part 200 moving beyond the limit position, thereby making it possible not only to prevent the second rail part 200 from deviating from the sliding movement path thereof, but also to prevent damage to other members due to further sliding movement of the second rail part 200.

In another embodiment, although not shown in the drawings, when locking is released, and the second rail part 200 is manually movable, sudden stop or sudden start of a vehicle may occur, or sliding movement of the second rail part 200 may be performed by a user using a strong stroke. In this case, each of the stoppers 150 limits the sliding movement path of the second rail part 200 to prevent sliding movement of the second rail part 200 moving beyond the limit position, thereby making it possible to prevent, in advance, damage to other members caused by the second rail part 200.

Meanwhile, the sliding transfer device for the vehicle according to an embodiment includes the sensors 300, as shown in FIG. 6.

Each of the sensors 300 is mounted at a corresponding one of the front of the first rail part 100 and the rear thereof and is configured to generate a sensing signal when the second rail part 200 reaches the set limit position thereof.

More preferably, each of the sensors 300 is formed as an electronic contactless sensor such as an infrared sensor or an ultrasonic sensor. The sensor 300 formed as a contactless sensor may prevent problems caused by using a conventional contact sensor. More specifically, the sensor 300 may prevent various problems such as sensor damage due to vibration, contact noise, and physical error, and mechanical wear and damage due to frequent operation.

A controller 400 receives a sensing signal generated by the sensor 300 and selectively controls, based on the sensing signal, the operation of the drive motor M for sliding movement of the second rail part 200.

In other words, the controller 400 receives the sensing signal indicating that the second rail part 200 slides and reaches the limit position thereof, thereby performing a control operation of changing the rotation direction of the drive motor M.

That is, as shown in FIG. 9, when power for sliding movement of the second rail part 200 is applied to the drive motor M, the lead screw 200a is rotated at a predetermined speed through a reducer 160 configured to reduce the rotation speed of the drive motor M (refer to FIG. 2). In this case, when the controller 400 receives, from any one of the sensors 300, a sensing signal indicating that the second rail part 200 reaches the limit position thereof, the controller 400 controls the drive motor M so that the rotation direction of each of the lead screws 200a is switched from the forward direction to the reverse direction or from the reverse direction to the forward direction, thereby making it possible to prevent, in advance, a problem related to overload of the drive motor M.

When the second rail part 200 is slidably moved in one direction and reaches the limit position thereof in a state in which power is applied to the drive motor M, the second rail part 200 stays at the limit position. In this case, since the drive motor M is continuously driven, overload of the drive motor M inevitably occurs.

Therefore, in this state, the controller 400 performs a control operation of changing the rotation direction of the drive motor M to move the second rail part 200 in the other direction, thereby preventing, in advance, a problem related to overload of the drive motor M.

In addition, when the controller 400 receives a sensing signal indicating that the second rail part 200 slides and reaches the limit position thereof and does not receive, from a user, a separate control signal related to driving of the drive motor M, the controller 400 may perform a control operation of releasing the operation of the drive motor M to stop sliding movement of the second rail part 200 at the limit position. Through this configuration, a problem related to overload of the drive motor M may be prevented in advance.

Meanwhile, referring to FIG. 2, the sliding transfer device for the vehicle according to the embodiment may further include a cable part 600 and a cable body part 700.

The cable part 600 is electrically connected to a main wiring W of a storage part that is slidably moved with the second rail part 200.

The cable part 600 may include a connector member 610 and a withdrawal member 620.

The connector member 610 is electrically connected to the main wiring W located in the second rail part 200. More specifically, two connector members 610 are electrically connected to the main wiring W on both sides thereof facing each other.

More preferably, the connector member 610 includes a printed circuit board and serves to electrically connect the printed circuit board to the main wiring W.

In addition, the withdrawal member 620 is connected to the connector member 610 and extends in the left-and-right direction of the second rail part 200. More specifically, each of the withdrawal members 620 is wound in a corresponding one of the cable body parts 700 respectively mounted on the opposite sides of the first rail part 100.

Preferably, the withdrawal member 620 may be a typical flexible flat cable (FFC) made of a flexible and flat cable having an embedded solid wire layer including a plurality of conductor wires. Further, since the withdrawal member 620 may be modified into various shapes, it is possible to install the withdrawal member 620 in a relatively narrow space between the driver's seat and the front passenger seat.

The cable body part 700 is formed so that the wound cable part 600 is selectively withdrawn from the cable body part 700 or stored therein when the second rail part 200 is slidably moved in the forward-and-rearward direction of the first rail part 100.

The cable body parts 700 are respectively mounted on the opposite sides of the first rail part 100 and formed to protrude therefrom. Here, each of the cable body parts 700 is shielded from the outside by a separate cover.

Additionally, the cable body part 700 accommodates the cable part 600 made of the FFC therein and is formed to elastically support the cable part 600 therein.

In other words, the cable body part 700 provides elastic force in a direction in which the cable part 600 is wound in the cable body part 700 and, as such, tension of the cable part 600 may be maintained when the cable part 600 is withdrawn from the cable body part 700.

Accordingly, when the second rail part 200 is slidably moved, the cable part 600 connected to the main wiring W is withdrawn from the cable body part 700, and the length of the cable part 600 may be selectively adjusted according to the sliding movement direction, thereby making it possible to prevent a quality problem due to increased operational force and damage to the main wiring W that result from interference with peripheral parts when the length of the main wiring W increases.

According to embodiments of the present disclosure, when an upper rail slides along a lower rail, a movement guide formed to protrude from the lower rail allows the upper rail to slide in the longitudinal direction of the movement guide, and a contactless limit sensor configured to sense a sliding movement position of the upper rail is provided to change the direction of the upper rail or stop the movement thereof at a limit position of the front of the upper rail and a limit position of the rear thereof, thereby having an effect of preventing overload of a drive motor due to sliding movement of the upper rail.

In addition, according to embodiments of the present disclosure, stoppers are respectively provided at the front of the lower rail and the rear thereof, thereby having an effect of preventing the upper rail from sliding beyond the limit position thereof due to an error in the limit sensor or the like during electric operation. Further, each of the stoppers plays a damping role during manual operation, thereby having an effect of mitigating shock.

Furthermore, embodiments of the present disclosure provides a cable connected to a wiring mounted on the upper rail. When a console is slidably moved in the forward-and-rearward direction in a state in which the cable is fixed to the lower rail, the cable is withdrawn from a cable body part or stored therein, and the length thereof is selectively adjusted according to movement of the console, thereby having an effect of preventing, in advance, a quality problem due to increased operational force and damage to the wiring that result from interference with peripheral parts when the length of the wiring increases.

As is apparent from the above description, embodiments of the present disclosure provide a sliding transfer device for a vehicle, the sliding transfer device including a movement guide, formed to protrude from a lower rail and configured to allow an upper rail to be slidably moved in the longitudinal direction of the movement guide when the upper rail slides along the lower rail, and a contactless limit sensor, provided to sense a sliding movement position of the upper rail and configured to change the direction of the upper rail or stop the movement thereof at a limit position of the front of the upper rail and a limit position of the rear thereof, thereby having an effect of preventing overload of a drive motor due to sliding movement of the upper rail.

Furthermore, stoppers are respectively disposed at the front of the lower rail and the rear thereof, thereby having an effect of preventing the upper rail from sliding beyond the limit position thereof due to an error in the limit sensor or the like during electric operation. Additionally, each of the stoppers plays a damping role during manual operation, thereby having an effect of mitigating shock.

In addition, a cable is connected to a wiring mounted on the upper rail. When a console is slidably moved in the forward-and-rearward direction in a state in which the cable is fixed to the lower rail, the cable is withdrawn from a cable body part or stored therein, and the length thereof is selectively adjusted according to movement of the console, thereby having an effect of preventing, in advance, a quality problem due to increased operational force and damage to the wiring that result from interference with peripheral parts when the length of the wiring increases.

Embodiments of the present disclosure have been described in detail with reference to preferred embodiments shown in the drawings, but the embodiments are merely illustrative. It will be appreciated by those skilled in the art that various modifications may be made from the embodiments, and all or a part of the embodiments may be selectively combined with each other. Therefore, the true technical protection scope of the present disclosure should be defined by the technical spirit of the appended claims.

What is claimed is:

1. A sliding transfer device for a vehicle, the device comprising:
a first rail part fixable to a vehicle body;
a second rail part coupled to the first rail part and slidably movable in a forward-and-rearward direction of the first rail part;
a plurality of sensors comprising a first sensor mounted at a front side of the first rail part and a second sensor mounted at a rear side of the first rail part, wherein each of the sensors is configured to generate a sensing signal in a case in which the second rail part reaches a set limit position thereof; and
a controller configured to selectively control, based on the sensing signal, an operation of a drive motor for sliding movement of the second rail part.

2. The device of claim 1, wherein the first rail part comprises stoppers mounted spaced apart from the sensors and configured to limit a position of the second rail part moving beyond the set limit position.

3. The device of claim 2, wherein each of the stoppers comprises an elastic material and stands upright from a corresponding one of the front side of the first rail part and the rear side of the first rail part.

4. The device of claim 1, further comprising a guidance rail part shielding an upper part of the first rail part, wherein the guidance rail part comprises a pair of sliding slots extending in a longitudinal direction and configured to allow the second rail part to be slidably moved along the pair of sliding slots.

5. The device of claim 4, wherein the first rail part comprises shielding members respectively mounted on the front side of the first rail part and the rear side of the first rail part and configured to shield the pair of sliding slots selectively withdrawn and opened by the slidably movable second rail part.

6. The device of claim 1, wherein the second rail part is configured to be slidably moved in a state of being coupled to a movement guide protruding from the first rail part.

7. The device of claim 6, wherein the movement guide extends upwards with an inclination on an upper surface of the first rail part and is inserted into a mounting hole of the second rail part.

8. The device of claim 1, wherein, in response to receiving the sensing signal indicating that the second rail part reached the set limit position, the controller is configured to perform a control operation of changing a rotation direction of the drive motor.

9. The device of claim 1, wherein, in response to receiving the sensing signal indicating that the second rail part reached the set limit position, the controller is configured to perform a control operation of releasing the operation of the drive motor.

10. The device of claim 1, wherein each of the sensors comprises an electronic contactless sensor.

11. A sliding transfer device for a vehicle, the device comprising:
a first rail part fixable to a vehicle body;
a second rail part coupled to the first rail part and slidably movable in a forward-and-rearward direction of the first rail part;
a plurality of sensors comprising a first sensor mounted at a front side of the first rail part and a second sensor mounted at a rear side of the first rail part, wherein each of the sensors is configured to generate a sensing signal in a case in which the second rail part reaches a set limit position thereof;
a controller configured to selectively control, based on the sensing signal, an operation of a drive motor for sliding movement of the second rail part;
a cable part electrically connected to a main wiring that is slidably movable with the second rail part; and
a cable body part, wherein, in a state in which the second rail part is slidably moved in the forward-and-rearward direction of the first rail part, the cable body part is configured to allow the cable part to be selectively withdrawn therefrom or stored therein.

12. The device of claim 11, wherein the cable part comprises:
a connector member electrically connected to the main wiring; and
a withdrawal member connected to the connector member and extending in a left-and-right direction of the second rail part, wherein the withdrawal member is wound in the cable body part fixedly mounted on the first rail part.

13. The device of claim 12, wherein the withdrawal member comprises a flexible flat cable (FFC).

14. The device of claim 11, wherein the first rail part comprises stoppers mounted spaced apart from the sensors and configured to limit a position of the second rail part moving beyond the set limit position.

15. The device of claim 11, further comprising a guidance rail part shielding an upper part of the first rail part, wherein the guidance rail part comprises a pair of sliding slots extending in a longitudinal direction and configured to allow the second rail part to be slidably moved along the pair of sliding slots.

16. The device of claim 15, wherein the first rail part comprises shielding members respectively mounted on the front side of the first rail part and the rear side of the first rail part and configured to shield the pair of sliding slots selectively withdrawn and opened by the slidably movable second rail part.

17. The device of claim 11, wherein the second rail part is configured to be slidably moved in a state of being coupled to a movement guide that extends upwards with an inclination on an upper surface of the first rail part and is inserted into a mounting hole of the second rail part.

18. The device of claim 11, wherein, in response to receiving the sensing signal indicating that the second rail part reached the set limit position, the controller is configured to perform a control operation of changing a rotation direction of the drive motor.

19. The device of claim 11, wherein, in response to receiving the sensing signal indicating that the second rail part reached the set limit position, the controller is configured to perform a control operation of releasing the operation of the drive motor.

20. The device of claim 11, wherein each of the sensors comprises an electronic contactless sensor.
